(19) United States
(12) Patent Application Publication
(10) Pub. No.: US 2003/0173041 A1
(43) Pub. Date: Sep. 18, 2003

(54) Method for guiding a flexible screen material handling rolling door counterweight

(76) Inventors: Bernard Simon, Caluire et Cuire (FR); Antonello Lamarca, Pierre-Benite (FR)

Correspondence Address: GREENBLUM & BERNSTEIN, P.L.C., 1950 ROLAND CLARKE PLACE, RESTON, VA, 20191, US

(21) Appl. No.: 10/297,583

(22) PCT Filed: Apr. 27, 2001
(86) PCT No.: PCT/FR01/01303

(30) Foreign Application Priority Data
Jun. 29, 2000 (FR) 00/08404

(51) Int. Cl. E06B 9/56

(52) U.S. Cl. 160/267.1

(57) ABSTRACT

The invention concerns a device for guiding a counterweight of a flexible screen material handling rolling door for an industrial building comprising two opposite side posts (2, 3) linked by a winding drum (4) mechanically linked to one of the ends of a motor reducer-brake fixed in the upper part of the vertical post (2) and enabling the vertical movements of the flexible screen between an opening position and a closing position and to the opposite end of a pulley (9) provided in the upper part of the post (3) and linked via a purchase belt (10) to a counterweight (11), comprising in the vertical post (2) of the material handling rolling door (1) two guide cables (16, 17) stretched between the terminal points and co-operating with guiding elements (31) fixed on the counterweight (11) to enable to guide said counterweight in all its directions when it is vertically displaced.

The present invention relates to a device for guiding a counterweight of a material handling door for an industrial building, comprising a roll-up or stack-up flexible screen.

French patent 2 679 955 discloses the device for guiding a counterweight of a stack-up material handling door comprising, in at least one of the vertical posts of the door, a vertical guide formed of a rigid tubular bar fixed at each end.

The counterweight is made either as a single piece or as several pieces stacked upon each other and pierced with a central bore for the passage of the tubular bar which forms the guiding device.

The guiding device according to the present invention is aimed at improving the guiding devices of the prior art by simplifying assembly, reducing costs of manufacture and improving safety in the operation of the counterweight.

The device for guiding a counterweight of a flexible screen material handling door of an industrial building according to the present invention comprises, in a vertical post of the material handling door, two guide cables stretched between two extreme points and collaborating with guide elements fixed to the counterweight to allow said counterweight to be guided in all its directions during its vertical movements.

The guiding device according to the present invention comprises cables which are fixed, on the one hand, in the upper part of the post to a reaction yoke secured to the post and, on the other hand, in the lower part of the post, to tensioners secured to a baseplate.

The guiding device according to the present invention comprises a reaction yoke which has a U-shaped profile determining, with the vertical face of the post, an empty space for the passage of the hauling belt, while fingers connecting the vertical face of the post to said yoke are provided in the empty space so as to be able to guide the hauling belt in its movements.

The guiding device according to the present invention comprises a reaction yoke povided with two opposed flanges each of which is pierced with a bore allowing the passage of the upper ends of each cable so as to form a loop which is secured by a clamping system.

The guiding device according to the present invention comprises tensioners which are connected at the opposite end from the fixings for the cables, by holding rings, pins secured to the baseplate forming the sole via which the post rests on the floor of the industrial building.

The guiding device according to the present invention comprises, in the upper part of the counterweight, a roller device secured to an eye bolt collaborating [lacuna] the guiding cables for guiding said counterweight.

The guiding device according to the present invention comprises, in the lower part of the counterweight, eye bolts which are carried by the same vertical axis as those arranged in the upper part of the counterweight so as to collaborate with the cables.

The guiding device according to the present invention comprises a roller device allowing the belt to be guided and centered in the upper part of the counterweight during its vertical movements according to the direction of rotation of the pulley.

The description which will follow with reference to the appended drawings given by way of nonlimiting examples will allow for a better understanding of the invention, of the characteristics it has and of the advantages it is able to afford:

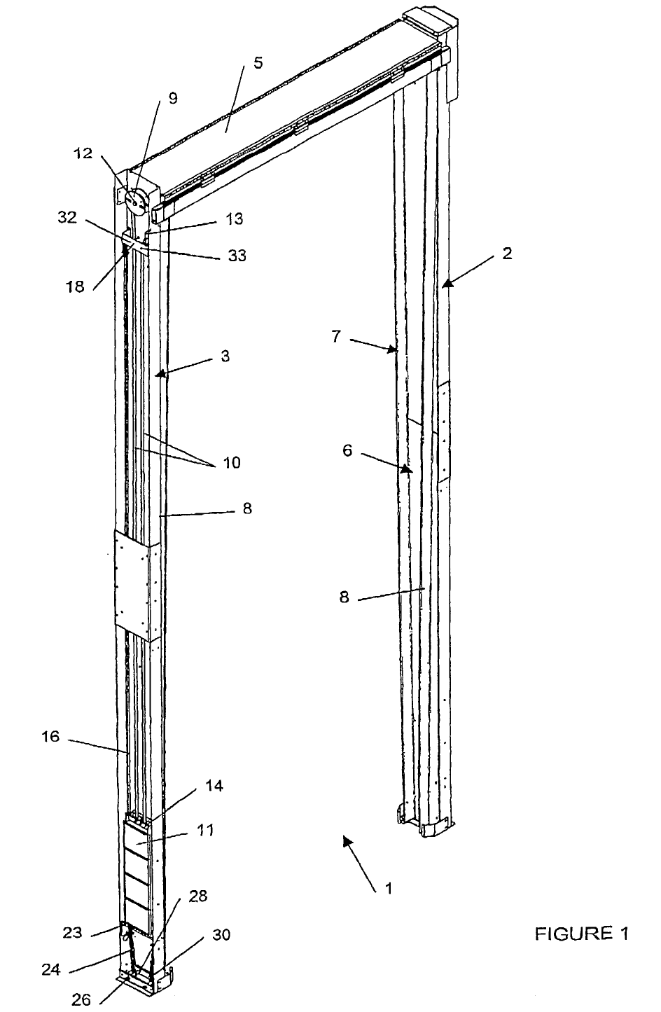

FIG. 1 is a perspective view showing a flexible screen door provided in one of its posts with the guiding device according to the present invention.

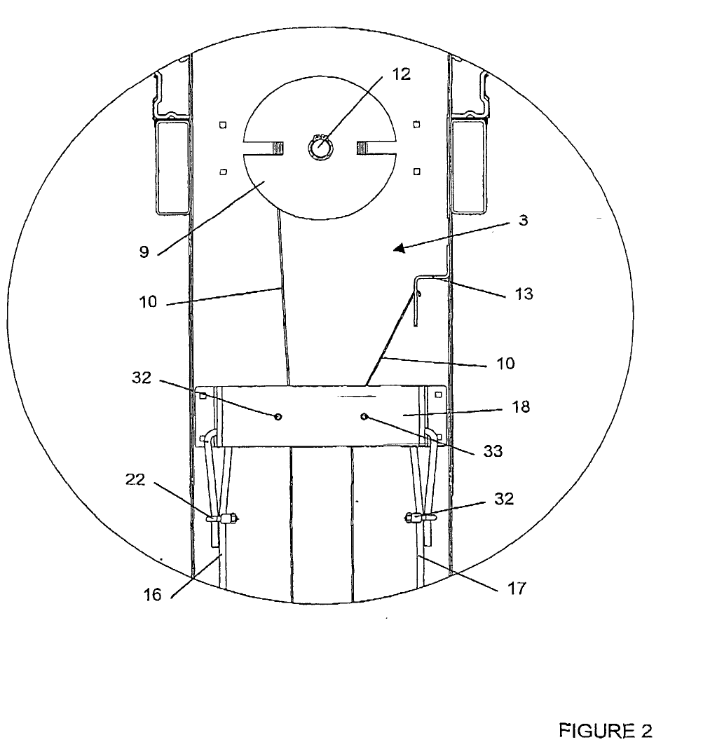

FIG. 2 is a front-on view showing the fixing of the guiding device in the upper part of the flexible screen material handling door.

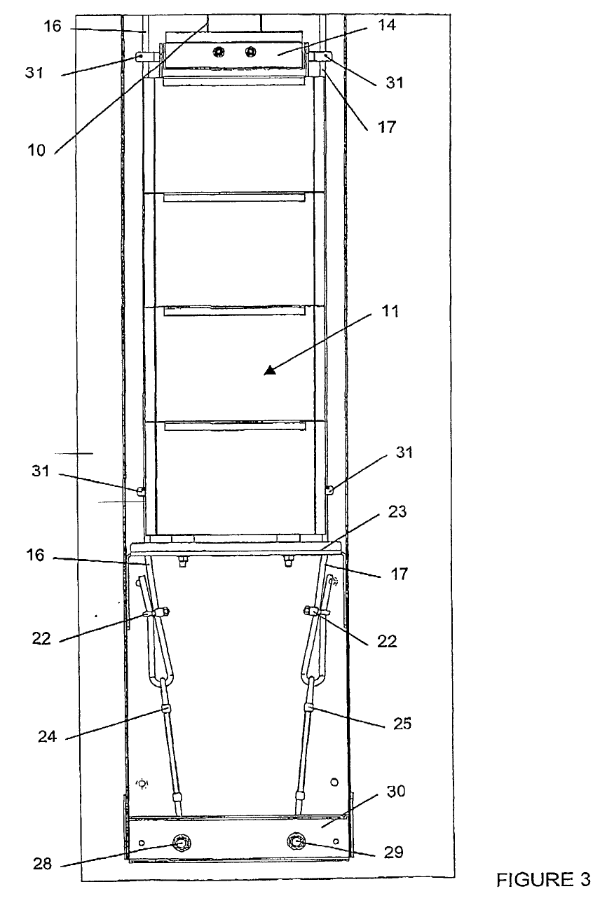

FIG. 3 is a front-on view depicting the retention of the guiding device on the counterweight of the flexible screen material handling door.

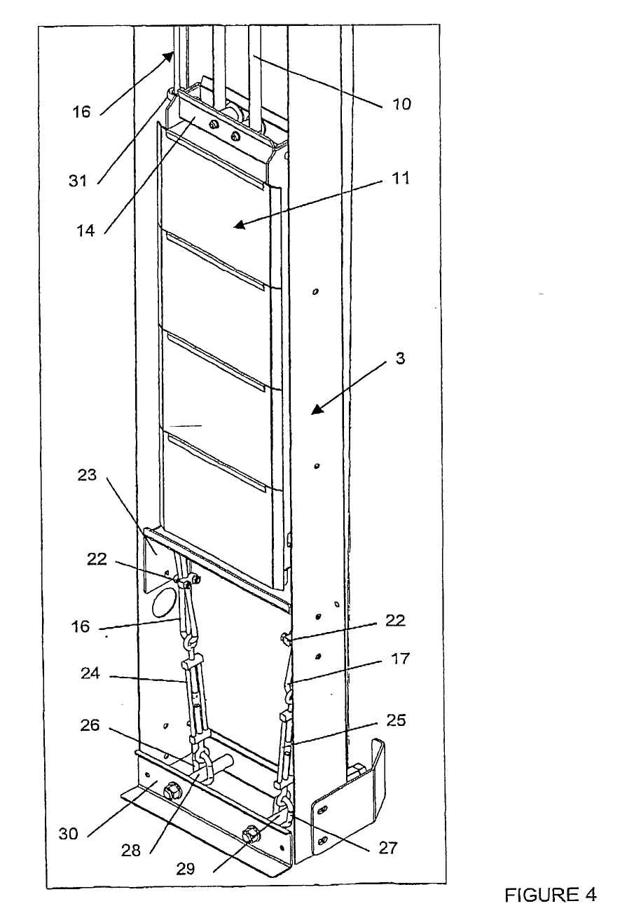

FIG. 4 is a perspective view illustrating the fixing of the guiding device in the lower part of a vertical post of the flexible screen material handling door.

FIGS. 1 to 4 show a material handling door 1 for an industrial building comprising two lateral and opposed posts 2 and 3 which are fixed against the vertical walls of an opening that is to be shut off.

The opposed and vertical posts 2 and 3 are connected to one another in the upper part of the material handling door 1 by a winding drum 4 protected by a cap 5 and allowing, by way of hauling straps, the flexible screen to be moved between an open position and a closed position.

Each vertical post 2, 3 comprises, on its outer face, a slideway 6 formed for example of straps 7, 8 to allow the flexible screen and its horizontal crossmembers to be guided during the vertical movements of said screen.

The winding drum 4 is mechanically connected at one of its ends to a braked geared motor unit, not depicted, fixed in the upper part of the vertical post 2 and allowing vertical movements of the flexible screen between an open position and a closed position.

The winding drum 4 is secured on the opposite side from the geared motor unit to a pulley 9 arranged in the upper part of the post 3 and which is connected by a hauling belt 10 to a counterweight 11 consisting either of a single element or of several elements stacked up.

The pulley 9 is fixed on the output shaft 12 of the winding drum 4, while the belt 10 is secured, on the one hand, at one of its ends to the pulley 9, so as to be able to wind around it as the counterweight 11 rises and, on the other hand, at its opposite end, to one of the walls of the vertical post 3 by means of a mounting plate 13.

The latter is fixed to the vertical post 3 just below the pulley 9 so that the belt 10 forms, between its two extreme fixing points, a loop which passes via the counterweight 11.

What actually happens is that the belt 10 is connected to the counterweight 11 by means of a roller device 14 allowing said belt to be guided and centered in the upper part of said counterweight during its vertical movements according to the direction of rotation of the pulley 9.

The counterweight 11 is tied to a guiding device 15 allowing its movements inside the vertical post 3 to be guided.

The guiding device 15 consists of two cables 16, 17 stretched between two extreme points provided one in the upper part and one in the lower part of the vertical post 3.

The guiding device 15 comprises, in the upper part of the post 3 and just under the fixing mounting plate 13 used for fixing one of the ends of the belt 10, a reaction yoke 18 secured to said post.

The reaction yoke 18 has a U-shaped profile determining, with the vertical face 19 of the post 3, an empty space for the passage of the hauling belt 10.

The reaction yoke 18 comprises, in the empty space, fingers 32 and 33 connecting the vertical face 19 of the post 3 to said yoke so as to be able to guide the hauling belt 10 as it moves.

The reaction yoke 18 comprises two opposed flanges 20, 21 each of which is pierced with a bore for the passage of the upper ends of each cable 16 and 17 so as to form a loop which is secured by a clamping system 22.

Thus, the loops secured to the reaction yoke 18 constitute the extreme upper fixing points of the cables 16 and 17 of the guiding device 15.

The lower part of the post 3 comprises, above the floor of the industrial building, a horizontal bed plate 23 against which the counterweight 10 rests in the lowest position of its travel.

The cables 16 and 17 of the guiding device 15 pass through the horizontal bed plate 23 to collaborate respectively with tensioners 24 and 25 which are arranged in the space delimited by the bed plate 23 and the floor of the building.

The tensioners 24, 25 are connected at the opposite end from the fixing of the cables 16 and 17, by holding rings 26, 27, to pins 28, 29 secured to a baseplate 30 forming the sole via which the post 3 rests on the floor of the industrial building.

Thus, the cables 16 and 17 comprise loops closed by clamping systems 12 in order to be secured to the tensioners 24, 25 constituting the extreme lower fixing points of the cables 16 and 17 of the guiding device 15.

The guiding device 15, and more particularly the cables 16 and 17, are connected to the counterweight 11 by means of eye bolts 31 arranged in the upper and lower parts of said counterweight.

Thus, the structure of the counterweight 11 comprises, in its upper part and on either side of the roller device 14, eye bolts 31 each receiving a respective one of the guiding cables 16 and 17.

Also, the structure of the counterweight 11 is secured in its lower part to eye bolts 31 which are borne by the same vertical axis as those arranged in the upper part of the counterweight so as to guide the cables 16 and 17 perfectly, over the entire height of said counterweight.

What happens is that each eye bolt 31 has the guiding cables 16 and 17 passing through it, which guiding cables are stretched between the extreme upper and lower points so as to guide the counterweight 11 in all directions during its vertical movements inside the post 3.

The eye bolts 31 undergo an internal treatment to make them able to withstand, as the counterweight 11 moves, the rubbing against the guiding cables 16 and 17.

It will be readily understood from the above description that the counterweight 11 works in the opposite direction with respect to the flexible screen, that is to say that the screen is in the closed position when the counterweight is in the high position, and vice versa.

Thus, when the geared motor unit is no longer supplied with electricity, it is necessary to release the brake allowing the flexible screen to rise up from a closed position to an open position because of the difference in mass between the counterweight 11 and that of the flexible screen.

Furthermore, the counterweight 11 performs a safety function when the geared motor unit breaks down, preventing the flexible screen from falling.

Indeed, what happens is that since the mass of the counterweight 11 is slightly greater than that of the flexible screen, the latter is automatically raised to the open position.

It must also be understood that the foregoing description was given merely by way of example and that it does not in any way restrict the field of the invention, the scope of which would not be departed from if the embodiment details described were replaced with any other equivalent ones.

1. A device for guiding a counterweight of a roll-up or stack-up flexible screen material handling door for an industrial building, comprising two lateral and opposed posts (2, 3) connected by a winding drum (4) which is connected mechanically, on the one hand, at one of its ends, to a braked geared motor unit fixed in the upper part of the vertical post (2) and allowing the flexible screen to be moved vertically between an open position and a closed position and, on the other hand, at the opposite end of a pulley (9) arranged in the upper part of post (3) and which is connected by means of a hauling belt (10) to a counterweight (11), characterized in that it comprises, in the vertical post (3) of the material handling door (1), two guide cables (16, 17) stretched between two extreme points and collaborating with guide elements (31) fixed to the counterweight (11) to allow said counterweight to be guided in all its directions during its vertical movements.

2. The guiding device as claimed in claim 1, characterized in that the cables (16, 17) are fixed, on the one hand, in the upper part of the post (3) to a reaction yoke (18) secured to the post (3) and, on the other hand, in the lower part of the post (3), to tensioners (24, 25) secured to a baseplate (30).

3. The guiding device as claimed in claim 2, characterized in that the reaction yoke (18) has a U-shaped profile determining, with the vertical face (19) of the post (3), an empty space for the passage of the hauling belt (10), while fingers (32, 33) connecting the vertical face (19) of the post (3) to said yoke are provided in the empty space so as to be able to guide the hauling belt (10) in its movements.

4. The guiding device as claimed in claim 2, characterized in that the reaction yoke (18) has two opposed flanges (20, 21) each of which is pierced with a bore allowing the passage of the upper ends of each cable (16, 17) so as to form a loop which is secured by a clamping system (22).

5. The guiding device as claimed in claim 2, characterized in that the tensioners (24, 25) are connected at the opposite end from the fixings for the cables (16, 17), by holding rings (26, 27), to pins (28, 29) secured to the baseplate (30) forming the sole via which the post (3) rests on the floor of the industrial building.

6. The guiding device as claimed in claim 1, characterized in that the counterweight (11)comprises, in its upper part, a roller device (14) secured to an eye bolt (31) collaborating with the guiding cables (16, 17) for guiding said counterweight (11).

7. The guiding device as claimed in claim 1, characterized in that the counterweight (11) comprises, in its lower part, eye bolts (31) which are carried by the same vertical axis as those arranged in the upper part of the counterweight (11) so as to collaborate with the cables (16, 17).

8. The guiding device as claimed in claim 6, characterized in that the belt (10) is connected to the counterweight (11) by means of the roller device (14) allowing said belt to be guided and centered in the upper part of said counterweight during its vertical movements according to the direction of rotation of the pulley (9).
